(19) United States
(12) Patent Application Publication
(10) Pub. No.: US 2009/0224533 A1
(43) Pub. Date: Sep. 10, 2009

(54) SUPPORT SYSTEM FOR FLEXIBLE PIPE

(76) Inventor: James R. Richter, Lincolnshire, IL (US)

Correspondence Address: GREER, BURNS & CRAIN, 300 S WACKER DR, 25TH FLOOR, CHICAGO, IL, 60606, US

(21) Appl. No.: 12/045,317

(22) Filed: Mar. 10, 2008

(51) Int. Cl. F16L 3/08

(52) U.S. Cl. 285/61

(57) ABSTRACT

A support system for a flexible pipe loop installed in a pipe run extending along a pipe run axis. The loop includes at least a pair of pipe run elbows, a pair of flexible tube members, and at least one loop elbow having first and second open ends, and an inner bend. Each pipe run elbow connects the pipe run to one end of a respective tube member. The loop elbow's inner bend is disposed towards the pipe run. The loop elbow has a centerline which is displaced away from the pipe run axis. The support system comprises a hanger rod having a first end operatively configured to attach to the loop elbow at a point which is closer to the pipe run axis than the centerline of the loop elbow at the centerline's furthest distance from the pipe run axis.

### BACKGROUND OF THE INVENTION:

The present invention relates generally to the field of expansion pipe loops, used to compensate for and absorb movement in piping systems and more particularly to an improved support assembly for a flexible pipe loop.

In conventional piping installations, there is the inevitable problem of movement of pipes in the installation. Movement of the pipes may be caused by expansion, contraction, building movement, earthquake, explosion, or other factors. Such movement often causes the pipes to leak or break apart.

Flexible pipe loops have been employed to compensate for and absorb pipe movements. For example, U.S. Pat. No. 5,195,784 to Richter (1993) and U.S. Pat. No. 5,803,506 to Argersinger (1998) disclose such flexible pipe loops. While the Richter and Argersinger flexible pipe loops have gained a fair amount of acceptance in the industry, these flexible pipe loops each have one or more bends or elbows that typically require block or hanger support when the flexible pipe loop is installed in a horizontal position. Block supports that are typically used to support flexible pipe loop elbows, such as shown in FIG. 7 of the Argersinger patent, often cannot not be employed in ceilings or walls. Conventional hanger supports for flexible pipe loop elbows are typically connected to the apex or outermost point of each bend in the pipe loop, such as shown in FIG. 4 of the Richter patent, which causes a bending force on the flexible pipe members, particularly at the connection between the flexible pipe members and the rigid elbows, causing the flexible pipe loop members to sag downward, limiting the effectiveness of the flexible pipe loop to absorb movement. Such sagging also adds stress to the flexible pipe loop, and places stress on the connection between the flexible pipes and the rigid elbows, thereby decreasing the stability and life of the flexible pipe loop.

### SUMMARY OF THE INVENTION

In view of the above-described circumstances, a support system consistent with the present invention is provided for use with a flexible pipe loop installed in a non-vertical orientation in a pipe run so that the flexible pipe loop is inhibited from sagging and reducing the stress on the flexible pipe loop and joints and the effectiveness of the pipe loop to absorb movement in the pipe.

The pipe run is divided at a location along its run to form a pair of open ends. The pipe loop includes a pair of oppositely disposed pipe run elbows each having first and second open ends, a pair of flexible tube members each having first and second open ends, and at least one loop elbow having a first open end, a second open end, and an inner bend. The first open end of each pipe run elbow is connected to a respective one of the open ends of the pipe run. The second open end of each pipe run elbow is connected to a respective one of the first open ends of the flexible tube members. The first open end of the at least one loop elbow is connected to a respective one of the second open ends of the pair of flexible tube members, such that the inner bend of the loop elbow is disposed towards the pipe run. The support system comprises a first hanger rod having a first end and a second end. The first end of the first hanger rod is operatively configured to attach to the inner bend of the loop elbow or another point on the loop elbow, such that at least one of the flexible tube members is inhibited from sagging when the second end of the first hanger rod is secured away from the inner bend of the loop elbow and above the pipe run. The loop elbow has a centerline which is displaced away from the pipe run axis, and the hanger rod is attached to the loop elbow at a point that is closer to the pipe run axis than the portion of centerline of the loop elbow that is furthest from the pipe run axis. By moving the connection point between the hanger rod and the loop elbow away from the apex and towards the pipe run, the bending moment on the flexible tube members is reduced. By placing the hanger rod connection point at or close to the joint connection between the flexible tube members and the loop elbow, the bending moment at the joint connection can be reduced nearly to zero.

In another implementation, the loop elbow is one of a pair of loop elbows disposed in a spaced-apart opposing relationship and the first open end of each loop elbow is connected to a respective one of the second open ends of the pair of flexible tube members. The pipe loop may include a third flexible tube member connected between and to the second open ends of the pair of loop elbows, such that the inner bend of each loop elbow is disposed towards the pipe run.

In this implementation, the support system further includes a second hanger rod having a first end and a second end. The first end of each of the first and second hanger rods is operatively configured to attach to the inner bend of a respective one of the loop elbows or another point closer to the pipe run axis than the portion of the centerline of the loop elbows which is furthest from the pipe run axis, such that the flexible tube members are inhibited from sagging when the second end of each hanger rod is secured above the pipe run and away from the inner bend of the loop elbow that is attached to the respective hanger rod.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 shows a perspective view of an exemplary support system for a flexible pipe loop consistent with the present invention, where the flexible pipe loop is installed in a horizontal position in a pipe run and is supported from above;

FIG. 2 shows a perspective view of another exemplary flexible pipe loop consistent with the present invention, where the flexible pipe loop is installed in a horizontal position in a pipe run and is supported from above; and

FIG. 3 shows a perspective partial view of another exemplary support system for the flexible pipe loop of FIG. 2.

FIG. 4 shows a perspective view of an exemplary support system for another flexible pipe loop consistent with the present invention, where the flexible pipe loop is installed in a horizontal position in a pipe run and is supported from below.

### DETAILED DESCRIPTION OF THE EMBODIMENTS

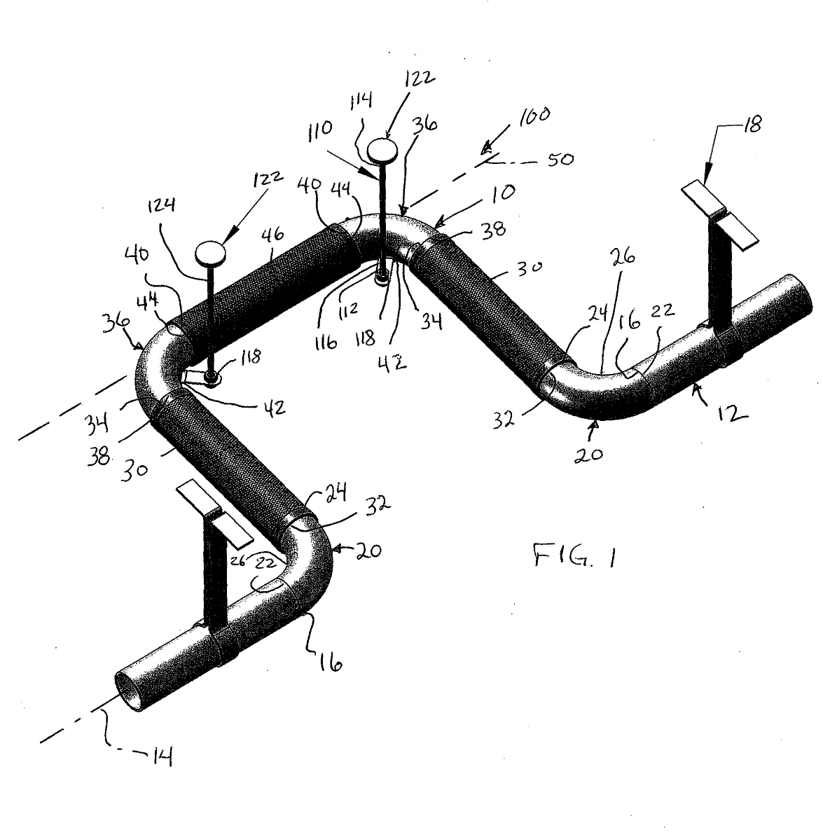

In FIG. 1, there is illustrated a support system 100 for a flexible pipe loop 10 consistent with the present invention, where the flexible pipe loop 10 is installed in a horizontal or non-vertical position in a pipe run 12 extending along a longitudinal axis 14. As discussed further below, the support system 100 inhibits the flexible pipe loop 10 from sagging when the flexible pipe loop is installed in a non-vertical orientation. The pipe run 12 is divided along its length to form a pair of open ends 16, which are attached to the pipe loop 10. The pipe run 12 may be supported by hanger supports or pipe guides 18.

As shown in FIG. 1, the pipe loop 10 comprises a pair of oppositely disposed pipe run elbows 20, each having a first open end 22 configured to mate with one of the open ends 16 of the divided pipe 12, a second open end 24, and a bend 26 (e.g., 30 degrees, 45 degrees, or as shown, 90 degrees) between the two ends 22 and 24. Other angles for the bend 26 could also be used. The first open end 22 of each pipe run elbow 20 may have an end fitting to be secured to the open end 16 of the pipe 12, such as by flanges with threaded fasteners (not shown in figures), male or female pipe threads, weld nipples, swivel unions, slip-on and stub-&-lap-joint flanges, sanitary fittings, flared tube fittings, grooved fittings, or other specially designed connectors, all known in the plumbing art.

The pipe loop 10 also includes a pair of flexible tube members 30 each having a first open end 32 and a second open end 34. The first open end 32 of each tube member 30 is connected to a respective one of the second open ends 24 of the pipe run elbows 20.

The pipe loop 10 further includes at least one loop elbow 36 having a first open end 38, a second open end 40, and an inner bend 42. In the embodiment shown in FIG. 1, the first open ends 38 of the loop elbows 36 are connected to a respective one of the second open ends 34 of the pair of flexible tube members 30, such that the inner bend of the loop elbow is disposed towards the pipe run 12. In the implementation shown in FIG. 1, the inner bend 42 of the loop elbows 36 is 90 degrees and the second open ends 40 of the loop elbows 36 are connected to an open end 44 of a third flexible or rigid tube member 46. The flexible tube members 30 each may comprise an inner corrugated hose and an outer braided cover or may comprise other types of flexible tubes, such as rubber tubes or corrugated hose with no outer braid cover. By use of such a construction, the flexible tube members 30 will permit and absorb movement of the pipe 12 along the x-axis, the y-axis, and the z-axis shown in FIG. 1, while imparting no thrust load to the pipe. Pipe run elbow 20 and loop elbow 36 may each be made from copper, stainless steel, bronze, or alloys of these or other metals, which may add a significant amount of weight to the pipe loop 10.

The loop elbows 36 have a centerline which is displaced away from the pipe run axis 14. In the embodiment of FIG. 1, the centerline of the loop elbows 36 is at its furthest distance from the pipe run axis 14 at the connection of the loop elbows with the tube member 46. The centerline at that point is the same as a centerline of the tube member 46, and is identified in FIG. 1 with reference number 50.

The support system 100 constructed in accordance with the present invention functions to counterbalance the loop elbows 36 and inhibit the flexible tube members 30 from sagging. The support system 100 includes a first hanger rod 110 having a first end 112 and a second end 114. The first end 112 of the first hanger rod 110 is operatively configured to attach to the inner bend 42 of the loop elbow 36, such that at least one of the flexible tube members 30 is inhibited from sagging when the second end 114 of the first hanger rod is secured away from the inner bend 42 of the loop elbow and above the pipe run 12.

The first end 112 of the first hanger rod 110 may be secured to a tab 116 extending inwardly (towards the pipe run axis 14) from the inner bend 42 of the loop elbow 36. The first hanger rod 110 may be secured to the tab 116 with fasteners 118, such as nuts engaging with a threaded portion of the hanger rod.

In the implementation shown in FIG. 1, the second end of the first hanger rod 110 is mounted to a structure 122 above the pipe run, such as a ceiling or a side wall.

The embodiment of FIG. 1 shows a second hanger rod 124 which supports the other loop elbow 36 and may be secured to that loop elbow in the same manner as described above with respect to the first hanger rod 110.

In this embodiment, the connection of the hanger rod 110 to the support connection comprising the tab 116 is positioned closer to the pipe run axis 14 than the centerline 50 of the loop elbows 36 at the centerline's furthest distance from the pipe run axis.

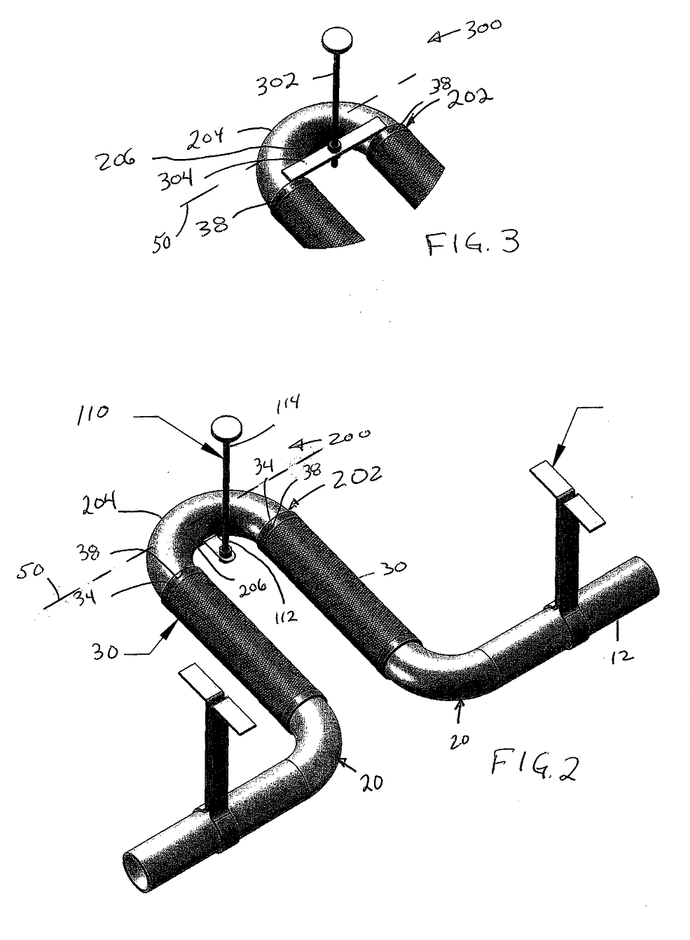

FIG. 2 shows a perspective view of another exemplary support system 200 for another flexible pipe loop 202 consistent with the present invention, where the flexible pipe loop 202 is installed in a horizontal or non-vertical position in a pipe run 12. The flexible pipe loop 202 includes a pair of oppositely disposed pipe run elbows 20 with first open ends 22 connected to the pipe 12 as described for the pipe loop 10. The pipe loop 202 also includes a pair of flexible tube members 30 with first open ends 32 connected to the second open ends 24 of the pipe run elbows 20. The pipe loop 202 further includes a single loop elbow 204. An inner bend 206 of the loop elbow 204 shown in FIG. 2 is 180 degrees facing towards the pipe run 12. However, the inner bend 206 may be between 10 to 180 degrees when the bends of the pipe run elbows 20 vary from the 90 degree bends illustrated. An open end 38 of each loop elbow 204 is connected to a respective one of the second open ends 34 of the pair of flexible tube members 30.

The support system 200 includes at least one hanger rod 110 attached to the inner bend 206 of one of the loop elbows 204 as described above for pipe loop 10. The first end 112 of the first hanger rod 110 is operatively configured to attach to the inner bend 206 of a respective loop elbow 204, such that the flexible tube members 30 are inhibited from sagging when the second end 114 of each hanger rod 110 is secured above the pipe run 12 and away from the inner bend 206 of the loop elbow 204 that is attached to the hanger rod 110.

In this embodiment, the connection of the hanger rod 110 to the support connection comprising the tab 116 is positioned closer to the pipe run axis 14 than the centerline 50 of the loop elbow 204 at the centerline's furthest distance from the pipe run axis.

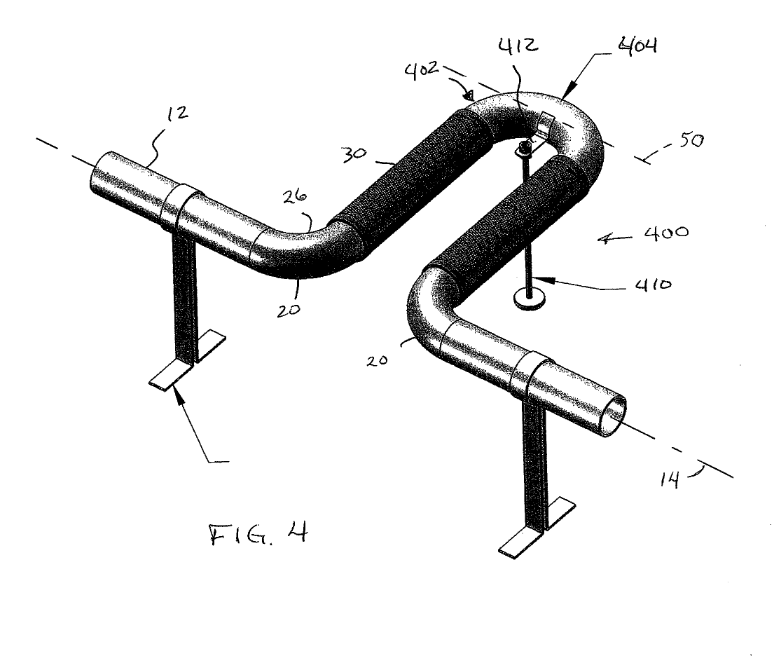

FIG. 3 shows a perspective view of another exemplary support system 300 for the flexible pipe loop 202 in FIG. 2. The support system 300 includes a hanger rod 302, which may be configured similar to the hanger rod 110 in FIG. 1. In the implementation shown in FIG. 3, the hanger rod 302 is attached to a support connection in the form of a strap 304. The strap 304 is secured to the loop elbow 204 at a position closer to the pipe run axis 14 than the centerline 50 of the loop elbow 204 at the centerline's furthest distance from the pipe run axis. As shown, the strap 304 may extend across legs of the loop elbow away from the bend in the elbow and towards, or at, the first open ends 38 of the loop elbow to engage the loop elbow at at least two points. Although the strap 304 is illustrated as being attached to a top side of the loop elbow 204, it may also be attached, such as by welding or soldering, to the lower side of the loop elbow. The strap 304 may be configured as a flat plate, as shown, or in other forms, such as a round rod, a beam having a substantial thickness, or even a strap that wraps around the lower sides of the loop elbow.

FIG. 4 shows a perspective view of another exemplary support system 400 for another flexible pipe loop 402 consistent with the present invention, where the flexible pipe loop 402 is installed in a horizontal or non-vertical position in a pipe run 12. The flexible pipe loop 402 includes a pair of oppositely disposed pipe run elbows 20 connected to the pipe 12 as described for the pipe loop 10. The pipe loop 402 also includes a pair of flexible tube members 30 connected to the pipe run elbows 20. The pipe loop 402 further includes a loop elbow 404. The inner bend 406 of the loop elbow 404 shown in FIG. 4 is 180 degrees. However, the inner bend 406 may be between 10 to 180 degrees and the pipe run elbows may have an inner bend 26 between 5 degrees and 90 degrees. The loop elbow 404 is connected to the pair of flexible tube members 30.

The support system 400 includes at least one support rod 410 attached to a support member 412 which may be in the form of a tab or strap that is secured to each loop elbow 404 at a position closer to the pipe run axis 14 than the centerline 50 of the loop elbow 404 at the centerline's furthest distance from the pipe run axis. In this embodiment, the pipe loop 402 is supported from below rather than from above as in the previous figures. In all other respects, the support system 400 may take on the various embodiments as described above.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A support system for use with a flexible pipe loop installed in a pipe run extending along an axis, which is divided at a location along its run to form a pair of open ends, the pipe loop including:
a pair of oppositely disposed pipe run elbows, each pipe run elbow having a first open end to be connected to a respective one of the open ends of the pipe run, and a second open end;
a pair of flexible tube members each having first and second open ends, the first open end of each tube member being connected to a respective one of the second open ends of the pipe run elbows; and
at least one loop elbow having a first open end, a second open end, an inner bend and a centerline extending along a length of the loop elbow, the first open end of the at least one loop elbow being connected to a respective one of the second open ends of the pair of flexible tube members, such that the inner bend of the loop elbow is disposed towards the pipe run and such that the centerline is displaced from the pipe run axis; the support system comprising:
a first hanger rod having a first end and a second end, the first end of the first hanger rod being operatively configured to attach to the loop elbow at a point which is closer to the pipe run axis than a portion of the centerline of the loop elbow which is furthest from the pipe run axis, such that at least one of the flexible tube members is inhibited from sagging when the second end of the first hanger rod is secured vertically away from the inner bend of the loop elbow.

2. The support system of claim 1, wherein the first hanger rod extends upwardly from the loop elbow.

3. The support system of claim 1, wherein the at least one loop elbow has a support connection formed on the inner bend of the loop elbow and the first end of the first hanger rod is adapted to engage the support connection.

4. The support system of claim 1, wherein the loop elbow includes a strap extending from the inner bend of the loop elbow adapted to attach to the first end of the first hanger rod.

5. The support system of claim 1, wherein the first hanger rod extends downwardly from the loop elbow.

6. The support system of claim 1, wherein the at least one loop elbow is one of a pair of loop elbows disposed in a spaced-apart opposing relation, the first open end of each loop elbow being connected to a respective one of the second open ends of the pair of flexible tube members, and the pipe loop further includes a third tube member connected between and to the second open ends of the pair of loop elbows, such that the inner bend of each loop elbow is disposed towards the pipe run.

7. The support system of claim 6, further comprising a second hanger rod having a first end and a second end, wherein the first end of each of the first and second hanger rods is operatively configured to attach to the inner bend of a respective one of the loop elbows at a point which is closer to the pipe run axis than the portion of the centerline of the loop elbows which is furthest from the pipe run axis, such that the flexible tube members are inhibited from sagging when the second end of each hanger rod is secured above the pipe run and away from the inner bend of the loop elbow that is attached to the respective hanger rod.

8. The support system of claim 7, wherein each loop elbow includes a strap extending from the inner bends of the loop elbows adapted to attach to the first ends of the hanger rods.

9. The support system of claim 6, wherein said third tube member is flexible.

10. The support system of claim 1, wherein the at least one loop elbow has a support connection in the form of a strap extending across legs of the loop elbow.

11. A support system for use with a flexible pipe loop installed in a pipe run, which is divided at a location along its run to form a pair of open ends defining a pipe run axis therebetween, the pipe loop including:
a pair of oppositely disposed pipe run elbows, each pipe run elbow having a first open end connected to a respective one of the open ends of the pipe run, and a second open end;
a pair of flexible tube members each having first and second open ends, the first open end of each tube member being connected to a respective one of the second open ends of the pipe run elbows; and
at least one loop elbow having a first open end, a second open end, and an inner bend, the first open end of the at least one loop elbow being connected to a respective one of the second open ends of the pair of flexible tube members, the loop elbow having a centerline displaced, at least at a point along its length, away from the pipe run axis, the support system comprising:
a first hanger rod having a first end and a second end, the first end of the first hanger rod being operatively configured to attach to a support connection rigidly secured to the loop elbow, the connection of the hanger rod to the support connection being positioned closer to the pipe run axis than the centerline of the loop elbow at the centerline's furthest distance from the pipe run axis.

12. An expansion loop member for use with a pipe extending along a longitudinal axis and divided along its length to form a pair of open ends, said pipe being subject to movement along said axis, said expansion loop member comprising:
a pair of elbow connectors each having a first connector end configured to mate with one of said open ends of said divided pipe and a bend between said connector end and an opposite second end;
a return member having a pair of open ends separated by a bend formed by at least one inner bend, with a centerline extending along a length of the return member;
a pair of flexible tube members each having one end connected to said second end of said elbow connectors and a second end connected at a connection point to one of said ends of said return member such that the centerline is displaced from the pipe axis;
a support connection formed on said return member at a point which is closer to the pipe axis than a portion of the return member centerline which is furthest from the pipe axis; and
a hanger rod attached to said support connection.

13. An expansion loop member according to claim 12, wherein said return member comprises a single 180 degree bend elbow.

14. An expansion loop member according to claim 12, wherein said return member comprises two 90 degree bend elbows connected by a third tube member.

15. An expansion loop member according to claim 14, wherein said third tube member is flexible.

16. An expansion loop member according to claim 12, wherein said support connection comprises a support rod attached directly to said return member.

17. An expansion loop member according to claim 12, wherein said support connection comprises a strap extending from the inner bend towards the pipe axis.

18. An expansion loop member according to claim 12, wherein said support connection comprises a strap engaging the return member at at least two points between the bend and the open ends.
